(19) United States
(12) Patent Application Publication
(10) Pub. No.: US 2026/0261793 A1
(43) Pub. Date: Sep. 3, 2026

(54) LOUDSPEAKER IMPROVED BY HIGH-DENSITY FER MOLECULAR SIEVE, AND ELECTRONIC DEVICE

(71) Applicant: SSI New Material (Zhenjiang) Co., Ltd., Zhenjiang, Jiangsu (CN)

(72) Inventors: Lei Zhang, Zhenjiang, Jiangsu (CN); Mingbo Guo, Zhenjiang, Jiangsu (CN); Yuanhong Ma, Zhenjiang, Jiangsu (CN)

(21) Appl. No.: 19/165,079

(22) PCT Filed: Mar. 15, 2024
(86) PCT No.: PCT/CN2024/081857

§ 371 Date: Sep. 12, 2025

(30) Foreign Application Priority Data
Mar. 15, 2023 (CN) 202310259049.8

(51) Int. Cl. H04R 1/28; H04R 1/02

(52) U.S. Cl. CPC H04R 1/2811; H04R 1/02

(57) ABSTRACT

The present disclosure discloses a loudspeaker improved by a high-density FER molecular sieve, and an electronic device. A rear cavity of the loudspeaker is filled with the high-density FER type molecular sieve. A raw powder of the FER molecular sieve has a non-flake micro morphology, a thickness-to-width ratio of ≥1:20 and <1:1, and a loose bulk density of greater than 0.15 g/cm³. The rear cavity of the speaker provided by the present disclosure is filled with the high-density FER molecular sieve with a specific raw powder morphology, which increases the acoustic compliance of air in the rear cavity, and thereby improving performance of the loudspeaker in a low-frequency band.

The present application claims priority to a Chinese Patent Application No. 202310259049.8 filed with the China National Intellectual Property Administration on Mar. 15, 2023 and entitled “LOUDSPEAKER IMPROVED BY HIGH-DENSITY FER MOLECULAR SIEVE, AND ELECTRONIC DEVICE”, which is incorporated in the present application by reference in its entireties.

### TECHNICAL FIELD

The present disclosure belongs to the field of speaker devices, and particularly relates to a speaker improved by a high-density FER molecular sieve, and an electronic device.

### BACKGROUND ART

With development of science and technology, people have increasingly high requirements for loudspeakers, especially mobile phone loudspeaker, which requirements are not only a small size and sound production, but also good sound quality while being small in size. The quality of sound is related to every aspect of design and manufacturing process of the loudspeaker, especially a designed size of a rear cavity of the loudspeaker. Under normal circumstances, a reduction in size of the rear cavity of the loudspeaker may significantly decrease a response in a low-frequency band, resulting in poor sound quality, and therefore, it is difficult to provide good sound quality under a condition of a very small rear cavity.

To solve the above problem, engineers have proposed various methods, such as 1) using a gas with better acoustic compliance to replace air as an atmosphere in rear cavity, 2) filling the rear cavity with foams such as melamine to increase the acoustic compliance, and 3) filling the rear cavity with porous materials such as activated carbon, zeolite, and silicon dioxide to increase a virtual rear cavity volume and improve the acoustic compliance. Among these, the third method has the most obvious effect.

Generally, FER zeolite is also called ferrierite. A synthesis Si/Al ratio range thereof is 8 to 30, morphology thereof is thin flake-like, and a loose bulk density thereof is approximately 0.15 g/cm³. There are also a few reports on FER with a synthesis Si/Al ratio greater than 100, or even all-silicon FER in a hydrogen fluoride system, but the morphology thereof is still thin flake-like, which is a large flake with a width of more than 20 μm and a thickness of approximately 1 μm. Such FER has poor acoustic effect due to its large flake size. There are also a few reports on introduction of seed crystals to obtain high-silicon small flake-like FER, such as small flake-like FER with a thickness of less than 100 nm, a width and a length of 2 μm to 6 μm. Such FER overcomes the problem of poor acoustic effect of large flakes, but since the morphology thereof is still thin flake-like, the bulk density thereof is extremely small, which is only approximately 0.15 g/cm³, and since a rear cavity volume of the loudspeaker system is limited and cannot be filled with high density, the corresponding acoustic effect per unit volume is still insufficient. The present disclosure obtains a high-density FER by controlling the morphology of FER, thereby solving the above problems of FER.

### SUMMARY

An object of the present disclosure is to provide a loudspeaker improved by a high-density FER molecular sieve, and an electronic device. A rear cavity of the loudspeaker is filled with a high-density FER molecular sieve material. The addition of the material can significantly improve low-frequency performance of the loudspeaker, and in practical applications, the material has strong resistance to performance degradation.

To achieve the above object, the present disclosure adopts the following technical solutions.

One aspect of the present disclosure provides a loudspeaker improved by a high-density FER molecular sieve, in which a rear cavity of the loudspeaker is filled with a high-density FER molecular sieve, and
a raw powder of the FER molecular sieve has a non-flake micro morphology, a thickness-to-width ratio of ≥1:20 and <1:1, and a loose bulk density of greater than 0.15 g/cm³.

The loose bulk density of the raw powder of the molecular sieve is mainly related to molecular sieve structure, crystallinity, raw powder size and raw powder morphology. The present disclosure changes the traditional flake-like morphology of FER into granule or sheet to obtain a high-density raw powder morphology while ensuring the crystallinity. The loose bulk density of the FER molecular sieve is preferably 0.20 g/cm³ to 0.8 g/cm³.

Thickness, width and length in the micro morphology of the raw powder of the FER molecular sieve in the present disclosure are defined as follows: in a three-dimensional space, the smallest dimension is defined as thickness, the next largest dimension is defined as width, and the longest side is defined as length.

According to the loudspeaker of the present disclosure, preferably, a thickness-to-width ratio of the FER molecular sieve is ≥1:15, and more preferably ≥1:10. Still more preferably, the thickness-to-width ratio of the FER molecular sieve is ≥1:10 and ≤1:2. Further preferably, the thickness-to-width ratio of the FER molecular sieve is ≥1:5 and ≤1:2.

According to the loudspeaker of the present disclosure, preferably, the micro morphology of the raw powder of the FER molecular sieve is a non-flake morphology such as a sheet-like shape (thickness-to-width ratio ≥1:20 and <1:1, preferably ≥1:5 and ≤1:2), an ellipsoid-like shape, a sphere-like shape, a block-like shape, and a column-like shape.

According to the loudspeaker of the present disclosure, preferably, a grain size (defined by the longest side) of the FER molecular sieve is ≥50 nm, more preferably ≥100 nm.

According to the loudspeaker of the present disclosure, preferably, the grain size (defined by the longest side) of the FER molecular sieve is ≤20 μm, preferably ≤10 μm.

According to the loudspeaker of the present disclosure, preferably, the FER molecular sieve mainly includes a framework and extra-framework cations. The framework mainly contains silicon dioxide and an oxide of a non-silicon atom M, in which a Si/M molar ratio is at least 80 or more, preferably 100 or more. M is preferably at least one of, but not limited to, Al, Fe, B, Ti, Zr, Ga, Cr, Mo, and the like, and more preferably Al. The extra-framework cations are preferably at least one of H ions, alkali metal ions, alkaline earth metal ions and transition metal ions, and more preferably at least one of Li, Na, K, Ba, Ca, Mg, Cu, Zn, and Ag. A content of the extra-framework cations is 0.05 wt. % to 1.5 wt. %.

Generally, a chemical composition of the framework of the FER molecular sieve mainly contains silicon dioxide and aluminum oxide. When Si/Al is lower than 80, the FER molecular sieve will significantly absorb moisture in the air and the moisture will occupy most of micropore channels of the molecular sieve, resulting in no low-frequency improvement effect. When Si/Al is high, although a moisture absorption rate is low, it presents significant synthesis challenges, and it is likely to generate impurities such as quartz and ZSM-5. Preferably, in the FER molecular sieve, M is Al, and the Si/Al molar ratio is greater than 80, and more preferably greater than 100.

Generally, FER molecular sieves are exchanged with cations before use to obtain different types of FER molecular sieves depending on a situation. Ammonium salts, alkali metal salts or alkaline earth metal salts are generally used to exchange with the molecular sieves. Ammonium salts mainly include ammonium chloride, ammonium nitrate, ammonium sulfate, ammonium carbonate, and the like. Alkali metals mainly include lithium salts, sodium salts, potassium salts, rubidium salts, and the like. Anions of alkali metal salts include chloride ions, sulfate ions, nitrate ions, and the like. Alkaline earth metals mainly include magnesium salts, calcium salts, barium salts, and the like. Anions of alkali metal salts include chloride ions, sulfate ions, nitrate ions, and the like.

According to the loudspeaker of the present disclosure, preferably, in the rear cavity, the FER molecular sieve is formed into a specific shape by addition of a binder to prevent the raw powder of the molecular sieve from entering a loudspeaker unit. The specific shape includes a granule-like shape (sphere, ellipsoid, ellipsoid with a pit in the middle, irregular granule, and the like), a sheet-like shape, a block-like shape, and the like. The rear cavity can be filled with the sheet-like or the block-like FER molecular sieve first, and then assembled, while the rear cavity is generally assembled first and then filled with the granule-like FER molecular sieve.

According to the loudspeaker of the present disclosure, preferably, a size of the granule-like shape in the specific shape is 80 μm to 2000 μm, and more preferably 100 μm to 1500 μm.

According to the loudspeaker of the present disclosure, preferably, a size of the sheet-like shape in the specific shape is determined according to a chamber body of the rear cavity of the loudspeaker, and preferably has a thickness of 100 μm to 1000 μm, and a length and a width of 3 mm to 100 mm.

According to the loudspeaker of the present disclosure, preferably, a size of the block-like shape in the specific shape is determined according to the chamber body of the rear cavity of the loudspeaker, and preferably has a thickness of 1 mm to 20 mm, and a length and a width of 3 mm to 100 mm.

Normally, directly synthesized FER molecular sieves are in a form of powders of 10 μm or less, and mostly need to be formed into a specific shape together with a binder before being placed in the rear cavity of the loudspeaker for use. Direct use of the raw powder without formation will cause the raw powder to enter the loudspeaker unit, affecting the performance of the loudspeaker. During the formation process of the molecular sieve, it is usually necessary to add the molecular sieve to be formed, a solvent, a binder and additives. Among these, the binder can be an inorganic binder or an organic polymer binder. Preferably, the inorganic binder includes activated alumina, silica sol, and the like. The organic polymer binder includes acrylates, epoxies, polyurethanes, and the like. The solvent mainly refers to water and various commonly used organic solvents, such as ethanol, toluene, acetone, and tetrahydrofuran. The additive refers to other substances added in very small amounts, usually less than 5%.

The loudspeaker provided by the present disclosure is filled with a high-density FER molecular sieve with a specific raw powder morphology in the rear cavity, which increases the acoustic compliance of air in the rear cavity, and thereby improving the performance of the loudspeaker in the low-frequency band.

Another aspect of the present disclosure provides an electronic equipment. The electronic equipment includes any one of the above loudspeakers. The electronic equipment includes but is not limited to a smart phone, a true wireless stereo (TWS) headset, a headphone, smart glasses, a smart watch, a VR device, an AR device, a tablet computer or a thin and light notebook computer.

### BRIEF DESCRIPTION OF DRAWINGS

FIG. 1 is an XRD pattern of a raw powder sample 1 prepared in Embodiment 1.

FIG. 2 is a SEM image of the raw powder sample 1 prepared in Embodiment 1.

FIG. 3 is a low-temperature nitrogen adsorption diagram of the raw powder sample 1 prepared in Embodiment 1.

FIG. 4 is a SEM image of the raw powder sample 1 prepared in Embodiment 2.

FIG. 5 is a SEM image of a low-density small-piece high-silicon comparative sample 2 molecular sieve in Comparative Example 2.

FIG. 6 is a SEM image of a large-piece high-silicon molecular sieve comparative sample 3 in Comparative Example 3.

FIG. 7 is a comparison chart of nitrogen adsorption at room temperature between the raw powder sample 1 in Embodiment 1 and a comparative sample 1 in Comparative Example 1.

FIG. 8 is a comparison chart of frequency response curves and impedance curves between rear cavities of the loudspeaker with and without a granule sample 1.

### DETAILED DESCRIPTION

In order to explain the present disclosure more clearly, the present disclosure is further described below with reference to exemplary examples. It should be understood by those skilled in the art that the following specific description is illustrative rather than restrictive, and should not be used to limit the scope of protection of the present disclosure.

All numerical specifications in the present disclosure (such as temperature, time, concentration, weight, and the like, including ranges of each thereof) are generally approximate values that can be appropriately changed by increments of (+) or (−) 0.1 or 1.0. All numerical specifications can be understood as being preceded by the term “approximately”.

### Embodiment 1

In this embodiment, a high-density FER molecular sieve was prepared and applied to a loudspeaker to test acoustic performance of the loudspeaker, including the following steps:

### 1) Preparing FER Molecular Sieve:

Synthesis of the FER Molecular Sieve was performed using sodium silicate as a silicon source (modulus 3.3, 7.9% Na₂O, 27% SiO₂), aluminum sulfate as an aluminum source, sodium hydroxide as a mineralizer 1 alkali source, sodium fluoride as a mineralizer 2 fluoride source, pyrrolidine as a template agent, lysine and sulfuric acid as modifiers, and water as a solvent. Specific conditions and a method are as follows. 1) Sodium silicate, water, sodium hydroxide, sodium fluoride and pyrrolidine (Pyr) were mixed and stirred in sequence to obtain a viscous solution A; 2) Aluminum sulfate, lysine (Lysine) and sulfuric acid were added to water at once to obtain a solution B; 3) The solution B was slowly added dropwise to the solution A, stirred at room temperature for 2 h to prepare a gel liquid having a molar ratio of 1.0 SiO₂: 0.0033 Al₂O₃: 0.015 Na₂O: 0.4 NaF: 0.4 Pyr: 0.1 H₂SO₄: 0.02 Lysine: 24 H₂O, and then react and crystallize at 160° C. for 96 h. The crystallized reactant was centrifuged, washed with water, dried at 100° C. overnight and calcined at 600° C. for 15 h to obtain sodium-type FER molecular sieve raw powder (Si/Al ratio is 150), which was recorded as a raw powder sample 1.

The raw powder obtained after calcination was directly tested to obtain an XRD spectrum, and as illustrated in FIG. 1, a structure of the prepared molecular sieve was indeed an FER molecular sieve.

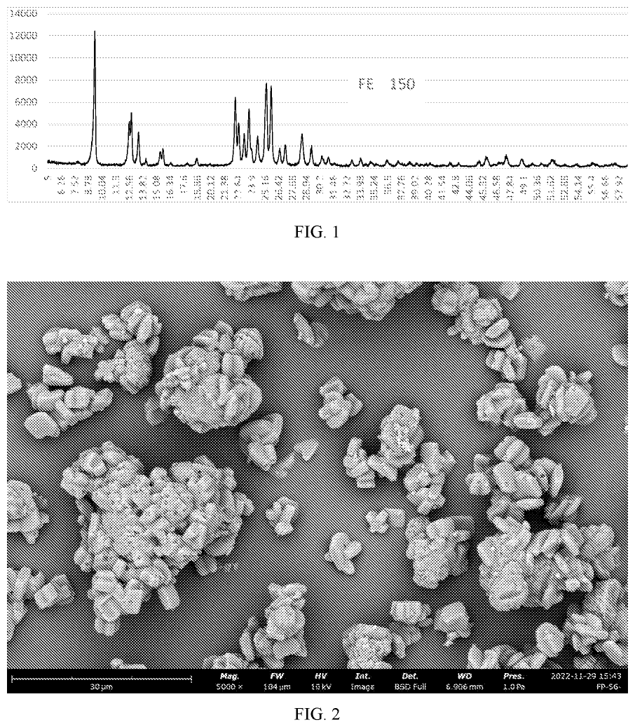

FIG. 2 is a SEM image of the calcined raw powder. It can be seen from FIG. 2 that a main raw powder size was approximately 1 μm thick, 4 μm to 6 μm long and wide, and a thickness-to-width ratio thereof was approximately 1:5. The calcined raw powder was slowly poured into a 100 mL measuring cylinder, flush with the 100 mL mark, and a mass thereof was measured as 41 g, and a corresponding loose bulk density thereof was 0.41 g/cm³.

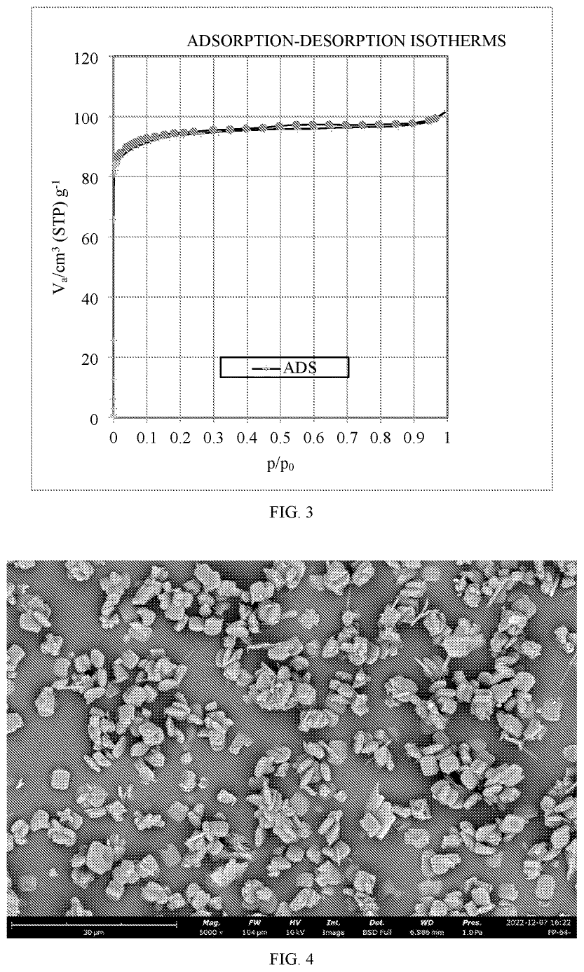

FIG. 3 illustrates low-temperature nitrogen adsorption characterization of the raw powder after calcination (measured at 77 K using Micromeritics ASAP 2020 specific surface area and pore size distribution analyzer). It can be seen from FIG. 3 that the molecular sieve is mainly formed by micropores in a low-pressure zone, with a BET of 369 m²/g.

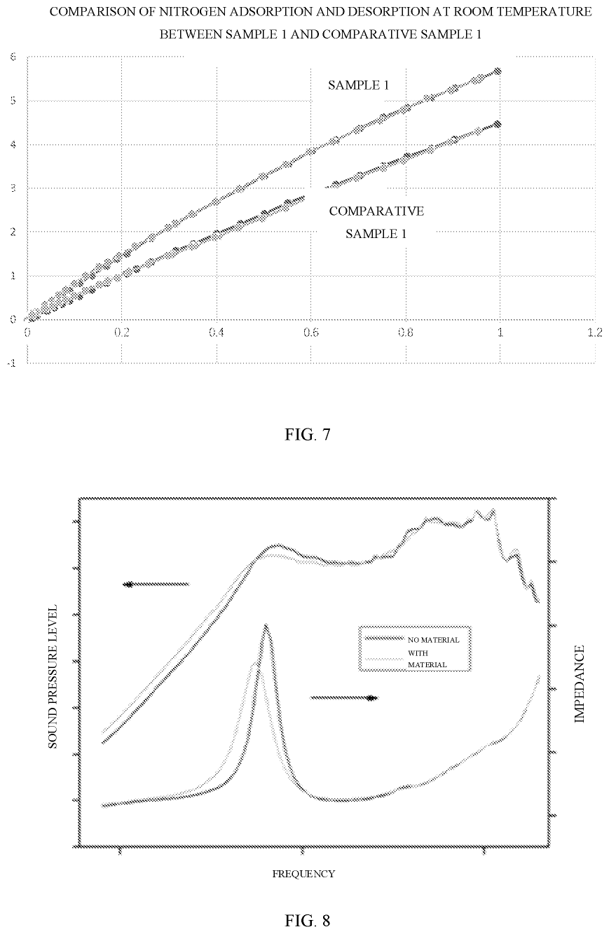

FIG. 7 illustrates nitrogen adsorption and desorption of the calcined raw powder at room temperature (measured at 298 K using Micromeritics ASAP 2020 specific surface area and pore size distribution analyzer), and the adsorption amount is 25% higher than that of Comparative Sample 1.

### 2) Adding Binder to Form Granule-Like Shape:

The calcined raw powder, water, and a binder (acrylate latex A, solid content 50%) were mixed into a slurry at a mass ratio of 48:50:12, and then spray-dried with a 400 μm nozzle (tower top 180° C., tower bottom 140° C., spray pressure 0.3 MPa) to obtain FER granules. Granules with a diameter of 270 μm to 330 μm were screened out and recorded as a granule sample 1 (average diameter 300 μm).

### 3) Testing Acoustic Performance:

A commercially available 1115-type loudspeaker was used. A volume of rear cavity in tooling was 0.4 cubic centimeters (0.4 cc for short), and 100% canned. Specific data is shown in Table 1. Acoustic low-frequency performance was improved by approximately 25 Hz as compared with Comparative Embodiment 1. An SPL sound pressure frequency response curve is shown in FIG. 8. After adding this material, a sound pressure value in a low-frequency band was significantly improved.

### Embodiment 2

In this example, a high-density FER molecular sieve was prepared and applied to a loudspeaker to test acoustic performance of the loudspeaker, which includes the following steps.

### 1) Preparing FER Molecular Sieve:

Based on Embodiment 1, the proportion of sulfuric acid was changed from 0.1 H₂SO₄ to 0.14, and other conditions were the same as those in Embodiment 1. The molecular sieve raw powder obtained after calcination was recorded as a raw powder sample 2.

FIG. 4 is a SEM image of the raw powder sample 2. As illustrated in FIG. 2, a main raw powder size was approximately 1 μm thick, and 4 μm to 6 μm long and wide, and a thickness-to-width ratio thereof was approximately 1:5. A measured loose bulk density of the raw powder sample 2 was 0.39 g/cm³.

### 2) Add Binder to Form Granule-Like Shape:

The formation ratio, conditions and equipment were the same as those in Embodiment 1, and a granule sample 2 (average diameter 300 μm) was obtained by the formation.

### 3) Test Acoustic Performance:

A commercially available 1115-type loudspeaker was used. A volume of rear cavity in tooling was 0.4 cubic centimeters (0.4 cc for short), and 100% canned. Specific data is shown in Table 1.

### Embodiment 3

In this embodiment, a high-density FER molecular sieve was prepared and applied to a loudspeaker to test acoustic performance of the loudspeaker, which includes the following steps.

### 1) Preparing FER Molecular Sieve:

Synthesis of the FER Molecular Sieve was performed using sodium silicate as a silicon source (modulus 3.3, 7.9% Na₂O, 27% SiO₂), aluminum sulfate as an aluminum source, sodium fluoride as a mineralizer 2 fluoride source, pyrrolidine as a template agent, lysine and sulfuric acid as modifiers, and water as a solvent. Specific conditions and a method are as follows: 1) Sodium silicate, water, sodium hydroxide, sodium fluoride and pyrrolidine (Pyr) were mixed and stirred in sequence to obtain a viscous solution A. 2) Aluminum sulfate, lysine (Lysine) and sulfuric acid were added to water at once to obtain a solution B. 3) The solution B was slowly added dropwise to the solution A, stirred at room temperature for 2 h to prepare a gel liquid having a molar ratio of 1.0 SiO₂: 0.0033 Al₂O₃: 0.4 NaF: 0.4 Pyr: 0.1 H₂SO₄: 0.02 Lysine: 24 H₂O, and then react and crystallize at 160° C. for 120 h. The crystallized reactant was centrifuged, washed with water, dried and calcined to obtain a sodium-type FER raw powder (Si/Al ratio is 150), exchanged with 2M NH₄Cl solution at 70° C. for 6 h, calcined at 550° C. for 2 h to obtain a hydrogen-type FER raw powder. The hydrogen-type FER raw powder was recorded as a raw powder sample 3.

A main raw powder size of the raw powder sample 3 (hydrogen-type FER molecular sieve raw powder) was approximately 2 μm thick, and 4 μm to 6 μm long and wide, and a thickness-to-width ratio thereof was approximately 1:2. A loose bulk density thereof was 0.46 g/cm³.

### 2) Adding Binder to Form Granule-Like Shape:

The calcined raw powder, water, and a binder (acrylate latex A, solid content 50%) were mixed into a slurry at a ratio of 48:50:12, and then spray-dried with a 300 μm nozzle (tower top 180° C., tower bottom 140° C., spray pressure 0.4 MPa) to obtain FER granules. Granules with a diameter of 80 μm to 120 μm were screened out and recorded as a granule sample 3 (average diameter 100 μm).

### 3) Testing Acoustic Performance:

A commercially available 1115-type loudspeaker was used. A volume of rear cavity in tooling was 0.4 cubic centimeters (0.4 cc for short), and 100% canned. Specific data is shown in Table 1.

### Embodiment 4

In this example, a high-density FER molecular sieve was prepared and applied to a loudspeaker to test acoustic performance of the loudspeaker, which includes the following steps.

### 1) Preparing FER Molecular Sieve:

Based on Embodiment 1, the proportion of lysine was adjusted from 0.02 to 0.01, and other conditions were the same as those in Embodiment 1, so that a raw powder sample 4 was obtained.

A main raw powder size of the raw powder sample 4 was approximately 338 nm thick, and 4 μm to 6 μm long and wide, and a thickness-to-width ratio thereof was approximately 1:15. A loose bulk density thereof was 0.32 g/cm³.

### 2) Adding Binder to Form Granule-Like Shape:

The prepared FER molecular sieve raw powder was granulated according to the conditions of Embodiment 3 to form a granule sample 4 with an average granule diameter of 100 μm.

### 3) Testing Acoustic Performance:

A commercially available 1115-type loudspeaker was used. A volume of rear cavity in tooling was 0.4 cubic centimeters (0.4 cc for short), and 100% canned. Specific data is shown in Table 1.

### Embodiment 5

In this embodiment, a high-density FER molecular sieve was prepared and applied to a loudspeaker to test acoustic performance of the loudspeaker, which includes the following steps:

### 1) Preparing FER Molecular Sieve:

Based on Embodiment 1, the proportion of lysine was adjusted from 0.02 to 0.00 (without lysine), and other conditions were the same as those in Embodiment 1, so that a raw powder sample 5 was obtained. A raw powder size was approximately 250 nm thick, and 4 μm to 6 μm long and wide, and a thickness-to-width ratio thereof was approximately 1:20. A loose bulk density thereof was 0.21 g/cm³.

### 2) Adding Binder to Form Granule-Like Shape:

The prepared FER molecular sieve raw powder was granulated according to the conditions of Embodiment 3 to form a granule sample 5 with an average granule diameter of 100 μm.

### 3) Testing Acoustic Performance:

A commercially available 1115-type loudspeaker was used. A volume of rear cavity in tooling was 0.4 cubic centimeters (0.4 cc for short), and 100% canned. Specific data is shown in Table 1.

### Embodiment 6

In this embodiment, a high-density FER molecular sieve was prepared and applied to a loudspeaker to test acoustic performance of the loudspeaker, which includes the following steps.

### 1) Preparing FER Molecular Sieve:

Based on Embodiment 1, the proportion of lysine was adjusted from 0.02 to 0.07, and other conditions were the same as those in Embodiment 1, so that a raw powder sample 6 was obtained.

A main raw powder size of the raw powder sample 6 was approximately 5 μm thick, and 8 μm to 20 μm long and wide, and a thickness-to-width ratio thereof was approximately 1:3. A loose bulk density thereof was 0.69 g/cm³.

### 2) Adding Binder to Form Granule-Like Shape:

The prepared FER molecular sieve was granulated according to the conditions of Embodiment 1 to form a granule sample 6 with an average granule diameter of 300 μm.

### 3) Test Acoustic Performance:

A commercially available 1115-type loudspeaker was used. A volume of rear cavity in tooling was 0.4 cubic centimeters (0.4 cc for short), and 100% canned. Specific data is shown in Table 1.

### Comparative Embodiment 1

A loudspeaker of an Apple X-generation mobile phone sold on the market was disassembled, and granules of a comparative sample 1 in a rear cavity were taken out for comparative testing. Acoustic performance thereof is shown in Table 1, and nitrogen adsorption under room temperature is shown in FIG. 7 (the sample was calcined to remove organic glue before the room temperature nitrogen test).

### Comparative Embodiment 2

In this comparative example, acoustic performance of a low-density small-piece high-silicon comparative sample 2 was tested.

Fumed silica, sodium aluminate, NaF, pyridine, NaOH, FER seed crystal and water were synthesized in a molar ratio of 1.0 SiO₂: 0.0033 Al₂O₃: 0.8 NaF: 1.5 Py: 0.025 Na₂O: 0.05 FER seed crystal: 24 H₂O to prepare a thin flake-like comparative sample 2. A Si/Al ratio thereof was 150. A raw powder thin flake size was approximately 50 nm to 100 nm thick, approximately 2 μm to 4 μm wide, and approximately 3 μm to 6 μm long, and a thickness-to-width ratio thereof was approximately 1:30. A loose bulk density thereof was 0.14 g/cm³.

The acoustic performance is shown in Table 1, and a SEM spectrum thereof is illustrated in FIG. 5.

### Comparative Example 3

In this comparative example, acoustic performance of a large-piece high-silicon comparative sample 3 was tested.

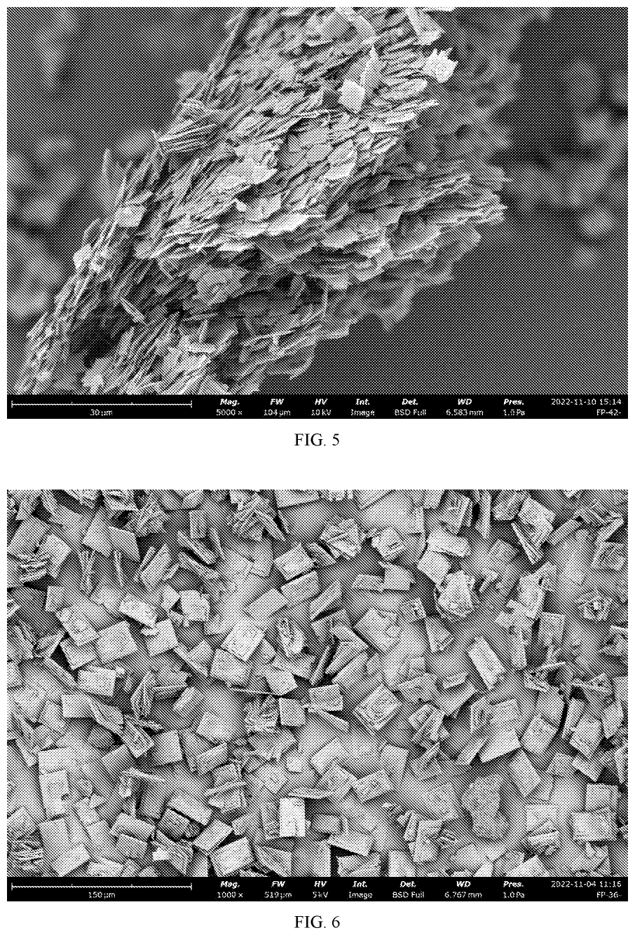

Fumed silica, sodium aluminate, NaF, pyridine, NaOH, and water were synthesized in a molar ratio of 1.0 SiO₂: 0.0033 Al₂O₃: 0.8 NaF: 1.5 Py: 0.025 Na₂O: 24 H₂O to prepare a large-piece high-silicon comparative sample 3. A Si/Al ratio thereof was 150. For specific synthesis conditions, see [Kamimura Y, Kowenje C, Yamanaka K, et al. Synthesis of hydrophobic siliceous ferrierite by using pyridine and sodium fluoride [J]. Microporous Mesoporous Mater., 2013, 181:154 to 159. A raw powder flake size was approximately 1 μm thick, approximately 35 μm wide, and approximately 60 μm long. A thickness-to-width ratio thereof was approximately 1:35. A loose bulk density thereof was 0.46 g/cm³. The acoustic performance thereof is shown in Table 1, and a SEM image is illustrated in FIG. 6.

TABLE 1
Resonance Frequency F0 Before and After Adding Molecular Sieve to Rear cavity of Loudspeaker

| | | | | After adding | | |
|---|---|---|---|---|---|---|
| | SEM raw | | No molecular | 0.4 cc | | Mass |
| | powder | | sieve added | molecular | | corresponding |
| | morphology | Loose | to rear | sieve to rear | | to 0.4 cc |
| | Thickness- | bulk | cavity of | cavity of | Reduction | molecular |
| | to-width | density | loudspeaker | loudspeaker | value | sieve |
| | ratio | g/cm³ | F0/Hz | F0/Hz | ΔF0/Hz | m/g |
| Granule sample 1 | 1:5 | 0.41 | 898.5 | 738.2 | 160.3 | 0.1650 |
| Granule sample 2 | 1:5 | 0.39 | 897.6 | 736.6 | 161.0 | 0.1589 |
| Granule sample 3 | 1:2 | 0.46 | 899.1 | 732.1 | 167.0 | 0.1820 |
| Granule sample 4 | 1:15 | 0.32 | 899.1 | 779.1 | 120.0 | 0.1275 |
| Granule sample 5 | 1:20 | 0.21 | 899.1 | 798.1 | 101.0 | 0.0852 |
| Granule sample 6 | 1:3 | 0.69 | 899.1 | 749.1 | 150.0 | 0.2740 |
| Comparative | 1:1 | 0.43 | 899.5 | 764.1 | 135.4 | 0.1724 |
| sample 1 | | | | | | |
| Comparative | Approximately | 0.14 | 899.1 | 816.4 | 82.7 | 0.0563 |
| sample 2 | 1:20 to 40 | | | | | |
| Comparative | 1:35 | 0.45 | 897.0 | 856.4 | 40.4 | 0.1821 |
| sample 3 | | | | | | |

As can be seen from Table 1, the reduction values in Embodiments 1 and 2 of the present disclosure are 25 Hz more than that in Comparative Embodiment 1 regarding improvement in low frequencies, and the acoustic performance of Embodiments 1 and 2 are significantly improved. The raw powder size of Comparative Embodiment 1 is too large, so that diffusion is limited, and the effect is limited. In Comparative Embodiment 2, mainly due to a low density, a filling mass of the granules is only approximately ⅓ of a normal filling mass, and therefore, it is impossible to fill the rear cavity with a limited volume of the loudspeaker with the same mass of granules, resulting in significantly inferior acoustic performance as compared with Comparative Embodiment 1, Embodiment 1 and Embodiment 2. Comparative Embodiment 3 is a large-piece FER morphology. The FER molecular sieve is originally a 2-dimensional channel molecular sieve, and the diffusion is easily limited by an outer surface thereof. When the raw powder size is too large, the diffusion is particularly seriously limited, resulting in the worst acoustic performance.

### Embodiment 7

The raw powder in Embodiment 1 was prepared into a slurry according to a mass ratio of raw powder:water:binder (acrylate latex A, solid content 50%) of 48:50:12, and then a cut rectangular block of melamine foam (9 mm wide, 6 mm high, 14 mm long) was placed in the slurry to soak and absorb the slurry, and then dried to obtain a block-like FER (mass: 0.30 g to 0.33 g).

A resonant frequency (f0) acoustic test was conducted in a 1 cc loudspeaker test tooling. After adding the block-like FER, f0 of the tooling was reduced from 810 Hz to 660 Hz. After adding 0.3 g of the granules of Embodiment 1 in the 1 cc tooling, f0 was reduced from 810 Hz to 640 Hz. From this comparison, it can be seen that although the acoustic performance in the case of the block-like FER is slightly worse than that of the granule-like FER, the low-frequency improvement effect is still significant.

### Embodiment 8

The raw powder in Embodiment 1 was prepared into a concentrated slurry according to a mass ratio of raw powder:water:binder (acrylate latex A, solid content 50%) of 48:35:24, and then the slurry was coated on a PP film as a bottom mold, and dried to obtain a sheet of approximately 150 μm thick (cut into a sheet of 14 mm in length and 9 mm in width, weighing approximately 0.006 g to 0.008 g).

A f0 acoustic test was conducted in a 1 cc loudspeaker test tooling. After adding 4 pieces of the sheet-like FER, f0 of the tooling was reduced from 810 Hz to 700 Hz, which indicates that the FER formed into a sheet still has a significant low-frequency improvement effect.

Obviously, the above-described Embodiments of the present disclosure are merely examples for clearly describing the present disclosure, and are not intended to limit embodiments of the present disclosure. For those having ordinary skills in the art, other different forms of changes or modifications can be made based on the above description. An exhaustive list of all embodiments is neither necessary nor possible, and obvious changes or modifications derived from the technical solution of the present disclosure are still within the protection scope of the present disclosure.

1. A loudspeaker improved by a high-density FER molecular sieve, wherein
a rear cavity of the loudspeaker is filled with the high-density FER molecular sieve, and
a raw powder of the FER molecular sieve has a non-flake micro morphology, a thickness-to-width ratio of ≥1:20 and <1:1, and a loose bulk density of greater than 0.15 g/cm³.

2. The loudspeaker according to claim 1, wherein
a loose bulk density of the FER molecular sieve is 0.20 g/cm³ to 0.8 g/cm³.

3. The loudspeaker according to claim 1, wherein
a thickness-to-width ratio of the FER molecular sieve is ≥1:15.

4. The loudspeaker according to claim 1, wherein
a thickness-to-width ratio of the FER molecular sieve is ≥1:10 and ≤1:2.

5. The loudspeaker according to claim 1, wherein
a grain size of the FER molecular sieve is ≥50 nm.

6. The loudspeaker according to claim 5, wherein
the grain size of the FER molecular sieve is ≤20 μm.

7. The loudspeaker according to claim 1, wherein
the FER molecular sieve comprises a framework and extra-framework cations, the framework contains silicon dioxide and an oxide of a non-silicon atom M, and a Si/M molar ratio is more than or equal to 80.

8. The loudspeaker according to claim 7,
wherein the non-silicon atom Mis Al.

9. The loudspeaker according to claim 1, wherein
in the rear cavity, a binder is added to the FER molecular sieve to form a specific shape, and the specific shape includes a granule-like shape, a sheet-like shape, and a block-like shape.

10. The loudspeaker according to claim 9, wherein
the formation in granule-like shape has a size of 80 μm to 2000 μm.

11. The loudspeaker according to claim 9, wherein
the formation in sheet-like shape has a thickness of 100 μm to 1000 μm, and a length and a width of 3 mm to 100 mm.

12. The loudspeaker according to claim 9, wherein
the formation in block-like shape has a thickness of 1 mm to 20 mm, and a length and a width of 3 mm to 100 mm.

13. An electronic device comprising the loudspeaker improved by a high-density FER molecular sieve, wherein
a rear cavity of the loudspeaker is filled with the high-density FER molecular sieve, and
a raw powder of the FER molecular sieve has a non-flake micro morphology, a thickness-to-width ratio of ≥1:20 and <1:1, and a loose bulk density of greater than 0.15 g/cm³.

14. The electronic device according to claim 13, wherein a loose bulk density of the FER molecular sieve is 0.20 g/cm³ to 0.8 g/cm³.

15. The electronic device according to claim 13, wherein a thickness-to-width ratio of the FER molecular sieve is ≥1:15.

16. The electronic device according to claim 13, wherein a thickness-to-width ratio of the FER molecular sieve is ≥1:10 and ≤1:2.

17. The electronic device according to claim 13,
wherein a grain size of the FER molecular sieve is ≥50 nm.

18. The electronic device according to claim 17,
wherein the grain size of the FER molecular sieve is ≤20 μm.

19. The electronic device according to claim 13, wherein the FER molecular sieve comprises a framework and extra-framework cations, the framework contains silicon dioxide and an oxide of a non-silicon atom M, and a Si/M molar ratio is more than or equal to 80.

20. The electronic device according to claim 19, wherein the non-silicon atom Mis Al.
